(19) United States
(12) Patent Application Publication
(10) Pub. No.: US 2007/0019798 A1
(43) Pub. Date: Jan. 25, 2007

(54) Method and apparatus for providing customized teleconference greetings

(76) Inventors: Kenneth J. Voight, Sugar Grove, IL (US); David S. Benco, Winfield, IL (US); Kevin J. Overend, Elmhurst, IL (US); Baoling S. Sheen, Naperville, IL (US); Sandra Lynn True, St. Charles, IL (US)

Correspondence Address: FAY SHARPE/LUCENT, 1100 SUPERIOR AVE, SEVENTH FLOOR, CLEVELAND, OH, 44114, US

(21) Appl. No.: 11/170,029

(22) Filed: Jun. 29, 2005

(51) Int. Cl. H04M 1/64; H04M 3/42

(52) U.S. Cl. 379/202.01; 379/88.01

(57) ABSTRACT

A method for providing a customized teleconference greeting. The method includes recording a vocalized greeting provided by a host, storing the recorded vocalized greeting, receiving calls from guest terminals operated by guest participants, sending audio greetings for the guest participants to the guest terminals including at least a portion of the recorded vocalized greeting. The guest terminals can then be bridged into a teleconference call session. The terminal operated by the teleconference host can also be bridged into the teleconference call session is so desired.

### BACKGROUND OF THE INVENTION

This invention relates to a method and apparatus for forming a teleconference using a host provided customized greeting.

While the invention is particularly directed to the art of telecommunications, and will be thus described with specific reference thereto, it will be appreciated that the invention may have usefulness in other fields and applications.

A teleconference, also referred to as a conference call, provides a useful form of communications between several parties. Typically, parties wishing to join a teleconference, also referred to a participants, dial up a teleconference provider using a telephone also referred to as a terminal. The teleconference provider plays a greeting to the teleconference participant which provides instructions for the participant to follow in order to join the teleconference. The teleconference provider then bridges the participants' terminals together to form the teleconference call session enabling the participants to communicate.

However, the greeting that the teleconference provider plays to the teleconference participants is a generic greeting provided to all participants of teleconferences. The generic greeting typically assists participants in taking the steps necessary to join the teleconference by providing instructional information, but can only convey limited information to participants due to its generic nature.

It is desirable to provide a new and improved system and method of forming a teleconference which can provide the participant intending to join the teleconference with more useful information tailored specifically to them and their corresponding teleconference.

### SUMMARY OF THE INVENTION

A method and apparatus for forming a teleconference having a host provided customized greeting is disclosed.

In one aspect of the invention, a method for forming a teleconference is provided. The method includes recording a vocalized greeting provided by a teleconference host, storing the recorded vocalized greeting, receiving calls from guest terminals operated by guest participants, and sending audio greetings for the guest participants to the guest terminals including at least a portion of the recorded vocalized greeting.

In accordance with another aspect of the invention, the method can include bridging the guest terminals into a teleconference call session.

In accordance with another aspect of the invention, the method can include bridging a terminal operated by the teleconference host into the teleconference call session.

In accordance with another aspect of the invention, a system for forming the teleconference with customized greeting is provided. The system includes means for recording a vocalized greeting provided by a host, means for storing the recorded vocalized greeting, means for receiving calls from guest terminals operated by guest participants, means for sending audio greetings for the guest participants to the guest terminals including at least a portion of the recorded vocalized greeting.

In accordance with another aspect of the invention the system can include means for bridging the guest terminals into a teleconference call session.

In accordance with another aspect of the invention, the system can include means for bridging a terminal operated by the teleconference host into the teleconference call session.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram illustrating a system for forming a teleconference having a host provided customized greeting;

FIG. 2 in a flow chart illustrating portions of a method for forming the teleconference having a host provided customized greeting; and

FIG. 3 is a flow chart illustrating portions of a method for forming the teleconference having a host provided customized greeting.

### DETAILED DESCRIPTION OF THE PREFERRED EMBODIMENTS

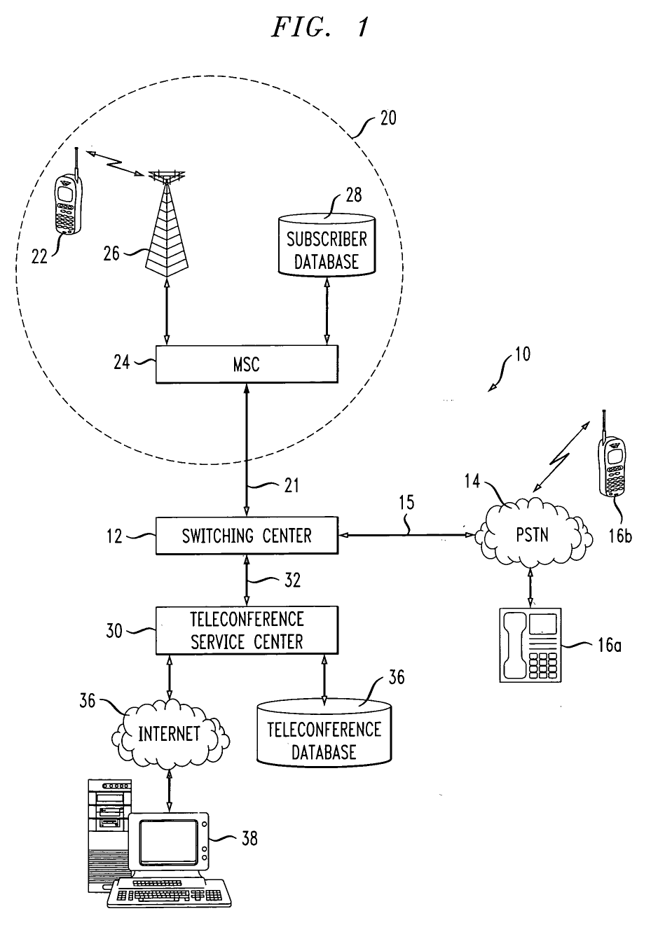

Referring now to the drawings wherein the showings are for purposes of illustrating the preferred embodiments of the invention only and not for purposes of limiting same, FIG. 1 provides a view of the overall preferred system according to the present invention. As shown, FIG. 1 illustrates portions of a telecommunications system shown generally at 10. The telecommunications system 10 includes a switching center 12 connected to the Public Switched Telephone Network (PSTN) 14 via connection 15 for connecting to a plurality terminals 16. The connection 15 can include a plurality of telephone line trunks. The terminals 16 can be Plain Old Telephone (POTS) terminals also known as landline telephones, only one of which is shown at 16a for simplicity. The terminals 16 can also include wireless terminals, one of which is shown at 16b, connected to the PSTN 14 via wireless telecommunications networks which are not shown for simplicity. The wireless terminals 16b are also known as mobile phones or cellular phones.

The switching center 12 is also connected to one or more wireless telecommunications networks, one of which is shown generally at 20, via connection 21 for connecting to a plurality of wireless terminals, only one of which is shown at 22 for simplicity. The connection 21 can include a plurality of telephone line trunks. The wireless network 20 can include a plurality of Mobile Switching Centers (MSC), one of which is shown at 24, connected to the Switching Center 12. Base stations, only one of which is shown at 26 for simplicity, provide over-the-air communication to the wireless terminals 22 connecting them to associated MSCS 24 for communication with other terminals. The MSC 24 is responsible for routing calls to and from the wireless terminals 22, performing call setups, and call registration, among other things. A subscriber database 28 can be connected to the MSC 24 for storing information relating to the services subscribed to by the person operating the wireless terminal, also referred to as a subscriber.

A teleconference service center 30, such as a server or other processing node suitable for providing the teleconferencing functionality as described herein, is connected to the switching center 12 by one or more phone line trunk groups 32. The teleconference service center 30 bridges the phone lines, and thus the terminals 16, 22 connected thereto, together to form the teleconference call session as described in further detail below. The teleconference service center 30 includes means for recording vocalized greetings provided by the host, such as for example a digital recording apparatus which is known in the art that receives the host's spoken greeting via the host's terminal 22 and the phone line connecting the terminal to the service center.

A teleconference database 34 is connected to the teleconference service center 30 for storing information including but not limited to host access codes, guest participant access codes, stored recorded vocalized greetings, and reservation information as described in further detail below. The stored information is associated with the hosts using account codes, access codes, or in other suitable manners for access by the teleconference service center processing node 30.

The teleconference service center 30 can be connected to the Internet 36 enabling the host to connect to it using a computer 38 accessing a website, for example. The computer 38 can be a personal computer, a terminal having Internet access such as a wireless terminal, or other processing device capable of providing information and control commands remotely using the Internet. The host can contact the teleconference service center 30 via the website, enter an access code, and proceed to customize one or more teleconference greetings, and reserve teleconference bridges for forming the teleconference call session at scheduled days and times, as well as access account information for billing purposes, etc. using the computer 38.

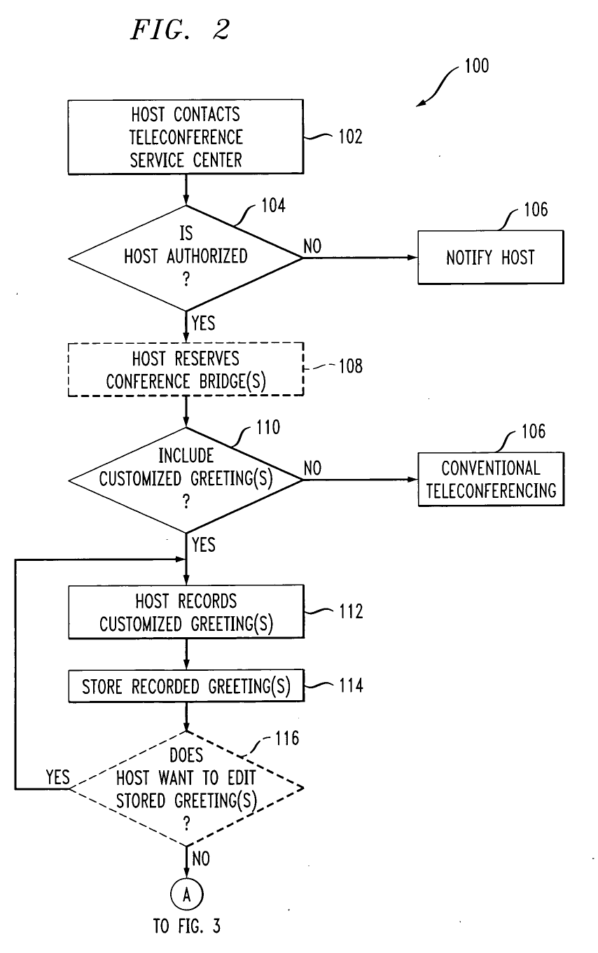

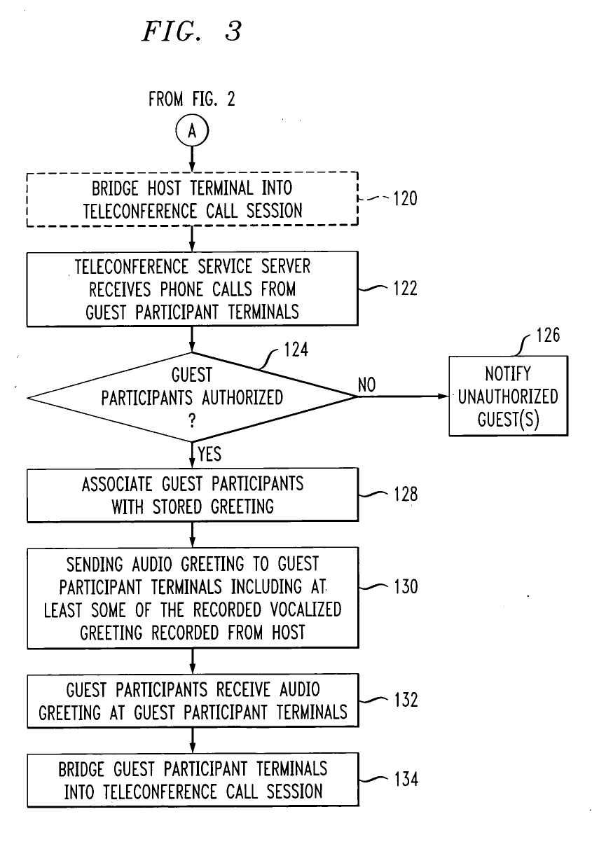

Referring now to FIGS. 2 and 3 the operation of the teleconference service system shall be described as a method for forming a teleconference shown generally at 100. The host contacts the teleconference service center at 102 such as by calling a phone number creating a call session connecting the host's terminal 22 with the teleconference service center. In the example provided herein, the host terminal 22 is described as a wireless terminal communicating with the teleconference service center 20 via the wireless communications network 20. However, it should be appreciated that the host terminal can be a POTS terminal 16a or wireless terminal 16b communicating with the teleconference service center 20 via the PSTN 14.

The teleconference service center 20 determines if the host is authorized to form teleconference call sessions at 104. For example, the host can provide a host access code upon calling the teleconference service center 20. The teleconference service center 20 can determine that the host is authorized by comparing the access code entered by the host with an access code stored in the teleconference database 36. If the host is not authorized at 104, the host is notified at 106 that the host is not authorized.

After the teleconference service center 20 determines that the host is authorized at 104, the host can reserve one or more conference bridges at 108. However, it should be appreciated that this step 108 can be considered optional. The host can schedule future teleconferences and reserve bridges having a suitable number of ports using voice commands provided using the host terminal 22. The teleconference service center 20 can prompt the host to enter the necessary voice commands and process the host's commands in a known manner to generate the reservations. Alternatively, the host can reserve bridges by scheduling future teleconferences using a computer 38 connected to the teleconference service center 20 via the Internet 36, such as a website, as described above.

At 110 the teleconference service center 20 determines if the host would like to a include customized greeting for the teleconference. The teleconference service center 20 can prompt the host to indicate such using voice commands provided by the host terminal 22, or via commands given over the Internet 36, such as the via the website. If it is determined that no customized greetings are requested at 110, conventional teleconferencing can be performed at 112.

If it is determined that the host requests a customized greeting for the teleconference, the teleconference service center 20 records a customized vocalized greeting provided by the host at 114. The host can provide the customized vocalized greeting using the host terminal 22 or using the computer 38 connected to the website via the Internet connection 36. The vocalized greeting can be customized for playback to the particular guest participants the host invites to join the teleconference. For example, the vocalized greeting can summarize the topics to be covered during the teleconference, or it can indicate to the guest participants the materials, such as notes, memos, reports, etc. they may need to have for participating in the teleconference, or it can indicate that host or other expected participants will not be joining the conference call, or it can welcome the expected guest participants by name or company, or it can notify guest participants that the conference call has been cancelled, etc. It should be appreciated that the host can provide any customized vocalized greeting deemed suitable which is recorded from the host by the teleconference service center 20 at 114 and stored at 116. The customized vocalized greeting can be stored in the teleconference database 36 for replay to the guest participants as described below. The host can record and store a plurality of customized vocalized greetings in this manner, each of which can be associated with the corresponding scheduled teleconference and bridge reserved as described above.

The host can edit one or more stored customized greetings if desired, though it should be appreciated that this can be considered optional. The teleconference service center 20 can determine if the host wants to edit the one or more greetings at 118 such as by prompting the host to provide a verbal command using the host terminal 22 or via web based control scheme described above. The host can edit a recorded greeting by replacing it with a newly recorded vocalized greeting at 114 which is stored at 116. Alternatively, the host can edit a greeting by recording a new portion at 114 which is added to the stored greeting at 116. For example, the added portion can include new information the host forgot to mention in the greeting recorded prior.

The teleconference service center 20 can include the host in the teleconference at 120 by bridging the host terminal 22 into the teleconference call session in a known manner. It should be appreciated, that the teleconference may be conducted without the host participating and as such this step can be considered optional.

Guest participants intending to participate in the teleconference call the teleconference service center 20 using guest participant terminals 16. Each guest participant dials an appropriate phone number and creates a call session connecting the terminal 16 with the teleconference service center 20 which receives the phone calls at 122. The teleconference service center 20 determines if the guest participants are authorized to participate in the teleconference at 124. This can be accomplished by having the guest participants enter an authorized code using their terminals 16. The teleconference service center 20 compares the code entered with codes stored on the teleconference database 36. The authorization codes can also be used at 128 to associate the guest participants with the proper customized greeting stored in the teleconference database 36 at 116 as described above.

After it is determined that the guest participants are authorized to participate in the teleconference at 124, the teleconference service center 20 sends an audio greeting to the guest participant terminal. The audio greeting includes some or all of the customized vocalized greeting recorded by the host. The audio greeting can also include audio information not provided by the host such as further instructions in how to join the teleconference, audio prompts requesting the guest participant to say their name, or other audio information, although this may be considered optional. The guest participants receive the audio greeting at their terminals 16 at 132 in a known manner such as via their terminal speaker.

The teleconference service center 20 can then bridge the guest participant terminals into the teleconference call session at 134 by bridging the phone lines connecting them to the teleconference service center in a known manner to form the teleconference call session. It should be appreciated that any suitable number of guest participant terminals can be bridged together into the teleconference call session.

The teleconference service center 20 enables the host to provide useful information to the guest participants joining the teleconference with a recorded vocalized greeting. The recorded greeting can be customized to a particular teleconference and to the specific guest participants invited to join the teleconference.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method comprising:
determining a teleconference host is authorized to create a teleconference;
recording a vocalized teleconference greeting provided by the teleconference host;
storing the recorded vocalized greeting;
receiving calls from guest terminals operated by guest participants; and
sending audio greetings for the guest participants to the guest terminals including at least a portion of the recorded vocalized greeting.

2. The method defined in claim 1 further comprising bridging the guest terminals into a teleconference call session.

3. The method defined in claim 1 further comprising determining the guest participants are authorized to participate in the teleconference

4. The method defined in claim 1 wherein the step of determining the host is authorized further comprises consulting a subscriber database stored on a telecommunications network node.

5. The method defined in claim 1 further comprising the host editing the recorded vocalized greeting.

6. The method defined in claim 5 wherein the editing step further comprises:
recording a new vocalized greeting provided by the host; and
replacing the recorded vocalized greeting with the new recorded vocalized greeting.

7. The method defined in claim 5 wherein the editing step further comprises:
recording a new portion of the vocalized greeting provided by the host; and
adding the new portion of the vocalized greeting to the recorded vocalized greeting.

8. The method defined in claim 1 further comprising:
reserving a bridge for connecting the guest terminals for communication in the teleconference.

9. The method defined in claim 1 wherein the audio greeting includes audio portions not provided by the host in the recording step.

10. The method defined in claim 1 further comprising bridging the host terminal into the teleconference call session.

11. A system for forming a teleconference comprising:
means for determining a teleconference host is authorized to create a teleconference;
means for recording a vocalized greeting provided by the teleconference host;
means for storing the recorded vocalized greeting;
means for receiving calls from guest terminals operated by guest participants; and
means for sending audio greetings for the guest participants to the guest terminals including at least a portion of the recorded vocalized greeting.

12. The system defined in claim 11 further comprising means for bridging the guest terminals into a teleconference call session.

13. The system defined in claim 11 further comprising means for bridging the host terminal into the teleconference call session.

14. The system defined in claim 11 further comprising means for determining the guest participants are authorized to participate in the teleconference.

15. The system defined in claim 11 wherein the means for determining the host is authorized to create the teleconference further comprises a subscriber database stored on a telecommunications network node.

16. The system defined in claim 11 further comprising means for editing the recorded vocalized greeting.

17. The system defined in claim 11 further comprising:
means for reserving a bridge for connecting the guest terminals for communication in the teleconference call session.

18. A method comprising:
determining a teleconference host is authorized to create a teleconference;
recording a vocalized teleconference greeting provided by the teleconference host;
storing the recorded vocalized greeting;
receiving calls from guest terminals operated by guest participants;
sending audio greetings for the guest participants to the guest terminals including at least a portion of the recorded vocalized greeting;
bridging the guest terminals into a teleconference call session.

19. The method defined in claim 18 further comprising bridging a terminal operated by the host into the teleconference call session.
